(19) United States
(12) Patent Application Publication
(10) Pub. No.: US 2015/0242829 A1
(43) Pub. Date: Aug. 27, 2015

(54) SYSTEM AND METHOD FOR MANAGING A SINGLE POINT OF SALE OF PLURALITY OF MERCHANDISE FROM PLURALITY OF RETAILER

(71) Applicant: Michael Mahesh Bhaskaran, Bellevue, WA (US)

(72) Inventor: Michael Mahesh Bhaskaran, Bellevue, WA (US)

(21) Appl. No.: 14/187,757

(22) Filed: Feb. 24, 2014

(51) Int. Cl. G06Q 20/20; G06Q 30/02; G06Q 10/08; G06Q 30/06

(52) U.S. Cl. CPC G06Q 20/20; G06Q 30/0635; G06Q 30/0238; G06Q 30/0225; G06Q 10/083

(57) ABSTRACT

The invention discloses a system that includes a merchandise aggregation module configured for displaying and selling a plurality of merchandise for sale from a plurality of participating retailers. The system also includes a crowd sourcing module to provide discount information regarding the plurality of merchandise of the participating retailers to the merchandise aggregation module. The system further has an order processing module to receive a plurality of purchase order from a plurality of customers, process the purchase orders and deliver the merchandise ordered by the customer. The system provides different ways of delivering the merchandise according to the customer requirement. The system also helps the local retailers to increase the foot traffic to their store by sharing the discount sale to the customers.

### PRIORITY

The present invention claims priority under 35 USC section 119 based upon a provisional application filed on Feb. 22, 2013 with a Ser. No. 61/768,115.

### FIELD OF THE INVENTION

The invention relates to a system for managing a single point of sale of several of merchandise from multiple retailers. The invention particularly discloses a system and method where various crowd sourcing agents helps in providing discount information to enable a customer with a better shopping experience.

### BACKGROUND OF THE INVENTION

There are many online websites which give a common platform for number of retail shops to sell their products. These websites usually offer a discounted price to the customers, but quite often, local retailer clearance sale price is lesser than the usual discounted price offered through the website. None of the existing systems provide a way to get the information related to local clearance sale price to the public.

Not all the retailers display their local sale price or clearance sale price on their websites. Customers who are brand conscious and want to buy those items, goods, merchandise or services, are not aware of this opportunity unless they visit the local store. None of the existing systems provide brand conscious customers with a wider variety of products from local retailer shops. There are many systems in prior art which provide discounted products to customers but they may charge extra for shipping the items and there may also be a delay in receiving the ordered items by the customer. Many of the existing system won't give the required local discount sale details to the customers. And most of the existing system gives only limited option for delivery of goods.

There are many existing prior arts disclosing various sale platforms, but none of them discloses a system where efficient crowd sourcing and delivery of the products happen.

Thus a system is needed which provides a customer access to regular as well as sale prices in malls and local retailing shops and also provides an easy access to buy the items and delivery of goods which in turn increases the foot traffic into the mall.

### SUMMARY OF THE INVENTION

The present invention overcomes problems in the prior art and provides a system for managing a single point of sale of plurality of merchandise from plurality of retailers. The system includes a merchandise aggregation module configured to display and sell a plurality of merchandise from a plurality of participating retailers. The system also includes a crowd sourcing module configured to provide discount information such as discount pricing or other incentives to purchase regarding the plurality of merchandise of the participating retailers to the merchandise aggregation module. The system further has an order processing module configured to receive a plurality of purchase orders from a plurality of customers. The order processing module processes the purchase orders and delivers the merchandise to the customers.

According to an embodiment, the crowd sourcing module has crowd sourcing agents for providing discount information to the merchandise aggregation module. The crowd sourcing agent is at least one of a reseller, retailer or store associate. The crowd sourcing module is further configured to check the authenticity of the discount information provided by the crowd sourcing agents. The crowd sourcing module is further configured to send the discount information to a plurality of platforms.

According to another embodiment, the merchandise aggregation module further enables merchants to offer a combination of merchandise for sale at a single price.

According to another embodiment, the order processing module provides the customer with a plurality of delivery options. The delivery options include at least one of the following methods. The method includes receiving the ordered merchandise at the store, to deliver to an address specified by the customer, and to pick up the merchandise from a mall box.

According to some embodiment, the order processing module is capable of printing a shipping label at a store for the order received from the customer and also to track shipment of the ordered merchandise by the customer.

According to another embodiment, the order processing modules further has a mobile robot configured to collect the plurality of ordered merchandise by the plurality of customers from a plurality of stores to the slots in the mall box. The slot of the mall box has secure locking facility. The mall box has doors configured to display advertisements.

According to an embodiment, an order which is not received by the customer is returned to the merchant's store by the mobile robot.

According to another embodiment, the system further comprises an incentive module for distributing commission to the crowd sourcing agents.

According to an embodiment, the invention discloses a method for managing a single point of sale of a plurality of merchandise from a plurality of retailer. The method includes steps of displaying and offering for sale a plurality of merchandise from a plurality of participating retailers. The method also includes step of providing discount information regarding the plurality of merchandise of the participating retailers and step of receiving a plurality of purchase orders from a plurality of customers. The method further has step of processing the purchase orders and delivering the merchandise ordered by the customer according to the customer preference.

According to an embodiment, the step of delivering the merchandise has a plurality of options for delivering the merchandise. The plurality of options for delivering the merchandise may be one of the following, receiving the ordered merchandise at the store or delivering the ordered merchandise to an address specified by the customer and picking up the merchandise from a mall box.

According to an embodiment, the step of delivering the merchandise further has the following steps. The step of identifying the orders placed by plurality of customers. The step of collecting the merchandise according to the order placed, packing and labelling the merchandise with an address provided by the customer and the step of identifying the delivery option selected by the customer and delivering the merchandise according to the delivery option.

Thus, the retailers will have an additional channel for selling these (for example out of season, returned, slow moving inventory that takes up valuable rack space) merchandise, without having to physically move it to other discounted retailer location or shipping to other store location within their network thereby reducing significant supply chain costs.

### BRIEF DESCRIPTION OF THE FIGURES

The foregoing and other features of embodiments will become more apparent from the following detailed description of embodiments when read in conjunction with the accompanying drawings. Furthermore, elements that are known to be common and well understood to those in the industry are not depicted in order to provide a clear view of the various embodiments of the invention.

FIG. 1 illustrates an exemplary environment in which systems consistent with the principles of the invention may be implemented

FIG. 2 illustrates the block diagram of the system according to an embodiment of the invention.

FIG. 3a and FIG. 3b illustrate a mall box in accordance with an embodiment of the invention.

FIGS. 4 and 5 illustrate the flow diagram of the method according to an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. The following detailed description is, therefore, not be taken as limiting the scope of the invention, but instead the invention is to be defined by the appended claims.

The invention discloses a system for managing a single point of sale of plurality of merchandise from plurality of retailers. The system includes a merchandise aggregation module configured for displaying and selling a plurality of merchandise for sale from a plurality of participating retailers. The system also includes a crowd sourcing module to provide discount information regarding the plurality of merchandise of the participating retailers to the merchandise aggregation module. The system further has an order processing module to receive a plurality of purchase orders from a plurality of customers, process the purchase orders and deliver the merchandise ordered by the customer.

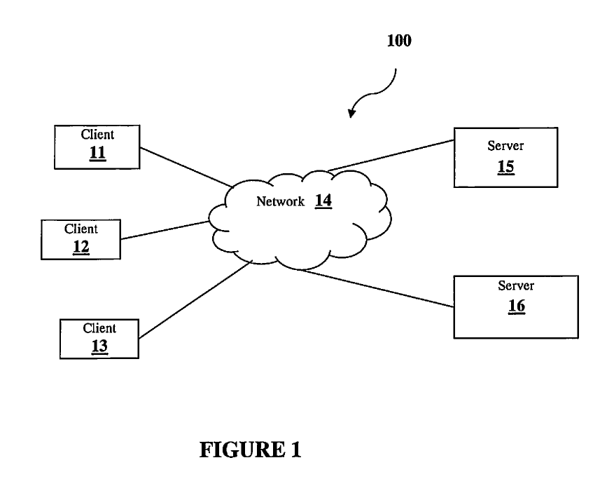

FIG. 1 illustrates an exemplary environment in which a system consistent with the principles of the invention may be implemented. The network includes several clients (11, 12, 13) where the system for managing a single point of sale of plurality of merchandise from plurality of retailer is implemented. These clients (11, 12, 13) interact with server (15) and transmit the data required for the system managing a single point of sale of plurality of merchandise from plurality of retailers through a network (14). The server (15) uses various databases for receiving and transmitting information required for monitoring. In some embodiments, the server (15) may also connect to another server (16).

In practice, there may be more number of servers and clients. In some situations, a server may perform the functions of all the two servers (15, 16) illustrated in the FIG. 1. It may be also contemplated that server may be one or many. It is also possible that in case of a standalone application mode, a server may not exist and all the logic may be implemented in the client.

A client (11) may include any device such a personal computer, laptop, mobile device, tablet, set top box (STB), television (TV), gaming devices, or any other types of device that can support two way interactions with the user either using a graphical user interface or through other interface mechanisms such as voice or gesture or video. Thus, client (11) may be any device that is capable of displaying or receiving the information related to the system.

In some cases all or part of the server configurations may be running on the client (11). In some cases, the client (11) may connect to multiple servers during the process of managing activity. In certain scenarios, the client (11) may perform the functions of server or server may perform client functions.

The above mentioned functions may be part of one server or several servers and each server may implement the functionalities of others. It may be possible that any of the server may be implemented using a cluster of servers involving two or more separate devices with all the other associated devices like a load balancer, a firewall, routers etc.

Network (14) may include for example a local area network (LAN), a wide area network (WAN), a Wide Local Area Network (WLAN), Wireless Personal Area Network (WPAN), Wireless Metropolitan Area Network (WMAN), a telephone network, such as the Public Switched Telephone Network (PSTN), an intranet, the Internet, a memory device, or a combination of networks. The network (14) may be wired, wireless, optical, or any other information transmission mechanisms.

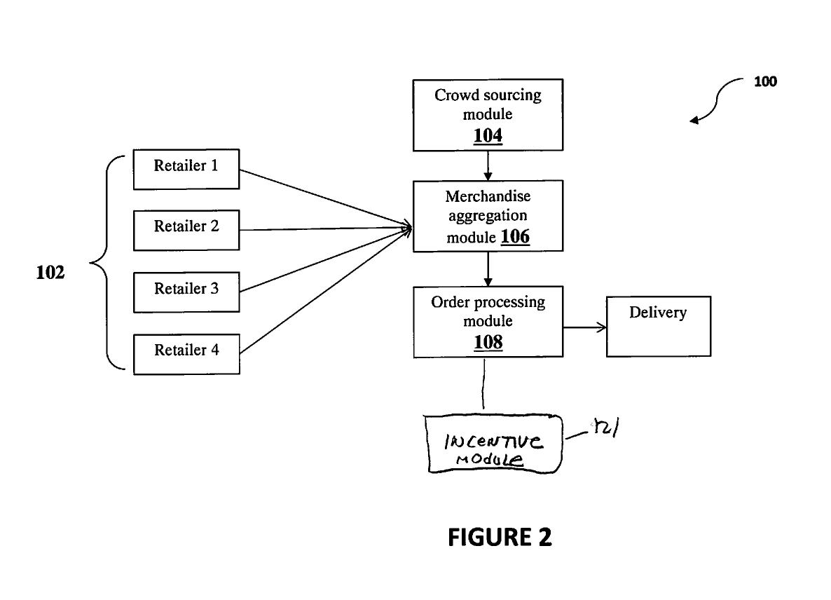

FIG. 2 illustrates an exemplary environment in which systems consistent with the principles of the invention may be implemented. The system (100) includes a merchandise aggregation module (102) configured for displaying and selling a plurality of merchandise for sale from a plurality of participating retailers (104). The system (100) provides a user interface for displaying various catalogues of all the participating retailers (104). The system (100) also provides a shopping cart using which the customers may make the purchase of the merchandise. The system (100) also includes a crowd sourcing module (106) to provide discount information such as discount pricing or other inducements to purchase regarding the plurality of merchandise of the participating retailers (104) to the merchandise aggregation module (102). The crowd sourcing module (104) has a number of crowd sourcing agents for providing discount information. These are the discount information which is not normally given by the dealers; it may be a part of clearance sale of the retailer. The crowd sourcing agents may be one or more of a reseller, retailer or store associate. The presence of crowd sourcing agents help the customers to find a good bargain deal for merchandise at retailer stores and listing the same on the user interface of the merchandise aggregation module (102). The user interface may exist as a part of a web site in accordance with the system. In certain scenarios, the crowd sourcing agents uses a hand held device to list local merchandise items to the merchandise aggregation module (102). The system (100) further has an order processing module (108) to receive a plurality of purchase orders from a plurality of customers, process the purchase orders and deliver the merchandise ordered by the customer. Once the user places an order through the merchandise aggregation module (102), the order processing module (108) receives the order. Once the order is received by the order processing module (108), it identifies the location and retailer store to which the order pertains and directs the order to the corresponding retailer store. The retailer store which has the hand held device receives the order. The hand held device is capable of printing a shipping label at the store by determining the delivery option.

According to an embodiment, the hand held device may be a hand held electronics devices with a software application to function as the crowd sourcing and as well as receiving the order and processing the order accordingly. The hand held device may be a smart phone or a tablet or any other electronic device capable of communicating with a network. The hand held device should have at least a scanner or a camera or both scanner and camera. The hand held device may also have an option to print the order, shipment address.

According to an embodiment, retail store associates, merchant or any one walking into the store affiliated to the system acts as the crowd sourcing agents. The crowd sourcing agent identifies a special deal available in the store. Then the crowd sourcing agent may either take a picture of the merchandise and/or barcode using the hand held device. The system then checks for the validity of the offer by searching on line and identifying the product attributes such as description of the product and guide/give options to select the right picture from online search and guide the merchant to set the price of the item and select the right address of the store or retail outlet where the special discount exists. The system then displays the special deal associated with that particular local store in the zip code or at a specific retail outlet address. For example, a retail associate working for Gap or Old Navy or a merchant walking into Gap or Old Navy store sees a pair of jeans listed at a clearance price of $10. The retail regular price for this jean is $100.00. The local store clearances are not always listed in the retailer's online stores. The merchant or retail store associate who acts as the crowd sourcing agent scans the item and from a menu of options, sets the new price, identifies the location or address of the store that has the discount sale and sets a time limit for the discount sale to show up on the web site. This enables the system to display the local deals instantly to the local and non-local customers either through mall box advertisement, through the TV screens in the mall, through the website of the system. Local customers are those living within the zip code and anyone living outside the zip code nationally or internationally is considered non-local by the system.

According to an embodiment, the order processing module (108) is capable of computing shopping cost for out-of-station or non-local customers, and also the total cost of the merchandise including applicable shipping and handling fees and sales tax. A sales tax engine/module of the system determines the appropriate taxes for in-state and out-of-state deliveries.

According to an embodiment, the crowd sourcing agent such as a retail associate is capable of setting time limits for displaying the discounted merchandise on the web site of the system.

According to an embodiment, the crowd sourcing module (106) checks the authenticity of the discount sale details. This may be done by comparing the discount sale details provided by the crowd sourcing agent with a number of data available with the system. The system (100) is fed with large amount of information such as rating of each store, their previous discount sale history, each brand's policy and so on. The aspect of checking the authenticity of the discount sale details provided by the crowd sourcing agent enables the system to feature only valid discount sale offers on the user interface. Once the authenticity of the discount is verified, the crowd source agent may take a picture of the product and upload the picture along with the new discounted cost of merchandise, cost of shipping and handling, and may compute applicable taxes depending on the final destination address of the customer. The crowd sourcing module (108) is further capable of sharing this discount information to multiple platforms such a website based on the system, to local TV channel and to the customers registered to the system.

According to an embodiment, the order processing module (106) provides the customers with various delivery options of merchandises after purchase. The options include picking up the merchandise at the store. The option also includes delivering to the address specified by the customer. In another scenario, the merchandise may be picked up by the customer from the mall box.

According to an embodiment, each customer has to get registered with the system. For registering, each customer has to fill the form and register on the website of the system. During or after the registration, the user has to provide details regarding their preferred delivery option. The system then provides an email address to each customer who gets registered. Later, the customer may use this email address to buy products from any online store through internet and get the items delivered to the store, mall box or get it delivered to their home address. In such cases, customers have to provide a standard delivery option while registering. It is possible to override the standard delivery option if the customer is using the website of the system for purchasing.

According to an embodiment, once the customer places a purchase order through the web site of the system, the order processing module (108) processes the purchase order and identifies the relevant store and sends the order-picking to the relevant merchant's hand held device. The merchant picks the order and full fills the order by scanning the barcode ID of the ordered merchandise by using the hand held device for order verification and then packs this into an appropriate shipment container. After the ordered merchandise is packed into its shipment container, the mobile app will write the order details to NFC (Near Field Communication) tag and/or shipment label which will be attached to the Shipment container. Once the order is complete, the merchant proceeds according to the delivery to the given delivery instructions on whether to leave this on the store for pickup or to drop off at the mall box or to wait for the carrier to come and pick up the order for delivery to the customers address.

According to one embodiment of the invention, the order processing module (108) is also capable of tracking the shipment details of the merchandise. The system is capable of tracking various shipment stages such as visibility for pick up i.e. whether the order is ready to be picked up by the customer if they have opted for pick up or if the customer has opted for shipment, the system checks whether the merchandise is in transit or has been delivered.

According to one embodiment, customers may also pick up their shipments from the store. In such a case, the store associate scans the bar code on the shipping label to ensure delivery confirmation when the customer picks up the shipment.

According to another embodiment, if the customer wants the merchandise to be delivered to the customer's address, then the hand held device triggers a message to the carrier to pick up the package at the store location immediately after the store associate scans the merchandise ordered by the customer in order to confirm the purchase. The carrier scans the package during pickup to confirm the pickup which helps in tracking the shipments. The carrier scans the package again after delivery to confirm the delivery. In this way, tracking of the shipment is also possible.

According to another embodiment, if the package is non local package, the local carrier may either drop it at a national carrier depot or facility for delivery to the customer.

According to one embodiment, the ordered merchandise may be placed inside a mall box for pick up by the customer. The mall box is a single stand alone box with several slots. Each slot is securely locked so that only the intended user is able to open the slot and pick up the item/items. In some embodiments, the slot may be locked using number lock wherein the number for un-locking the slot may be communicated to the customer after the order for purchase is placed. In another embodiment, the slots may be locked or unlocked by inserting a smart card designated to them. This is particularly applicable for the customers who have already registered with the system and got the loyalty smart card. The doors of the mall box has display unit in order to display one or more of the advertisements, instant deals, daily deals, monthly deals from a mall where the mall box is placed. The advertisement may even show the affiliated retail stores discount sale offers.

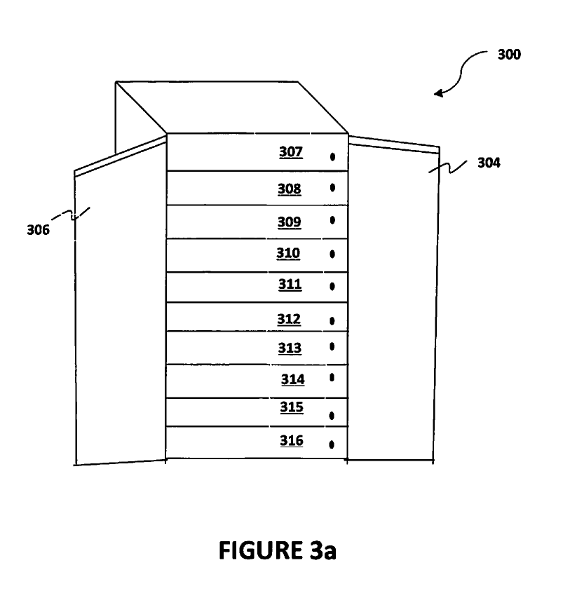

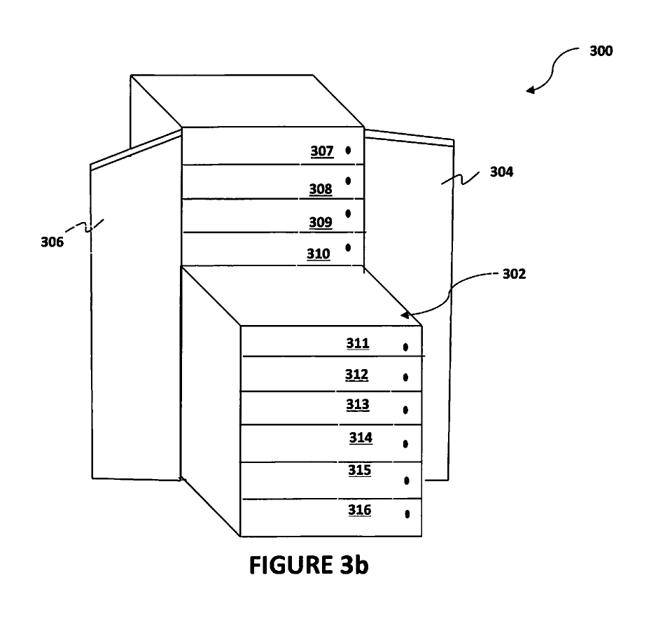

FIGS. 3a and 3b illustrate different views of mall box (300) and the mall robot (302). In FIG. 3a, mall robot (302) is placed along with the mall box (300). In some embodiments, the mall box (300) may itself act as mall robot. The figures given are for an illustration purpose only wherein the actual mall robot may have doors for each slot and will guide the store associate to place the completed order into the appropriate slot. The doors (304) and (306) may have a display unit for displaying the advertisements as well as various deals provided by the retailers. The mall box has a number of slots (307 to 316). In FIG. 3b, the mall box including the slots (311 to 316) may be a mall robot which is capable of moving around the mall and taking the orders from the various participating retailers. The mall robot may be in some other shape as well. The mall robot has powered wheels at the bottom enabling it to move around the mall.

According to an embodiment, the customer requests to have merchandise delivery at the mall box. The system continuously or periodically scan the emails of the website for purchase order ID's, shipment confirmation from the merchant and sends this message with order ID to the mall box controller. The retail store associate or the merchant packs the merchandise items from the store and puts this inside a mall box slot. The retail store associate has to key in the order number on their handheld device to open the mall box door. Here the mall box slots get opened using the use near field communication technology between handheld device and the mall box door with authentication. The order number to key into is given on the receipt or may be acquired from any other electronic data transfer methods.

According to another embodiment, when the customer requests a drop of merchandise at the mall box, then after the merchandise is placed in the mall box slot, a NFC (Near field communication) reader may detect the shipment by reading the tag. This tag may be attached to the order by the retailer. Once the mall box reads the tag, the mall box would send a message to the customer on his/her email ID and/or an SMS to the mobile phone indicating the package is ready for pickup. Once the merchandise is put inside the mall box, the customer will also get a 5 digit alphanumeric code to retrieve the package. The customer who comes to collect the merchandise from the mall box has to enter the 5 digit alphanumeric code to retrieve the package.

According to an embodiment, opening of the mall box slots may be done remotely through any mobile device such as tablet or cell phone installed with the required program. The box may have a small screen as a backup in case the near field communication is not operational so that the user may enter the alphanumeric number received during operation may be used.

According to an embodiment, the merchandise aggregation module (104) enables merchants to offer a combination of merchandise for sale at a single price. For example the system allows multiple merchandises from the store to be set for a single bundled price by the merchant. The customers may order online and pay a single price for a multiple (collection of similar or dissimilar items) items such as out of season merchandise, returns, other non-selling items and get them delivered either to mall box or their residential or commercial address. Once the customer orders online, the mall retail associate will pick all these items and leave them in the mall box if the customer requests mall box delivery.

According to an embodiment, the system further includes an incentive module for distributing commission to the crowd sourcing agents. That is the crowd sourcing agents, retail associates and merchants who walk into the store and identify the deals and sell them through the website, get paid a portion of the affiliate commission. The incentive module 121 may provide points for the retail associates and merchants who may collect such points and redeem them for gift cards at a later date.

According to an embodiment, the invention includes mobile robots known as mall robots. The mobile robots are configured to collect the merchandise ordered by the customer from the respective stores in to the slot in the mall box. In another scenario, the mobile robot collects the merchandise and facilitates the delivery of the merchandise to the customer according to the delivery options the customer has selected. If the customer has selected for mall box delivery, then the mobile robot places the items in the designated slot of the mall box and locks it. If the customer has opted for pick up from the mall, then the mobile robot places the collected merchandise from the stores in the designated place inside the mall to facilitate delivery. Once the merchandise has been placed in the designated place for delivery, then the mobile robot sends a message to the customer informing the location of the merchandise. In a certain scenario, the mall box itself may act as a mobile robot which is capable of going to each store for collecting the ordered merchandise for the respective clients.

According to one embodiment, the mall robot may be an automatic guided vehicle which may also be used as a returns centre for participating retailers in the mall. The mall robot locates a customer within the mall and allows him to return the product into the compartment.

According to another embodiment, the mall robot may collect customer orders from various stores and bring order to a central location for pickup. The customers may pickup their orders or can get the delivery to the preferred addresses.

According to one embodiment, a delivery driver or carrier may locate the mall robot and pickup all the contents for local delivery. In another embodiment, the mall robot could also be directly loaded into the driver's vehicle and can be used for storing packages during the delivery route.

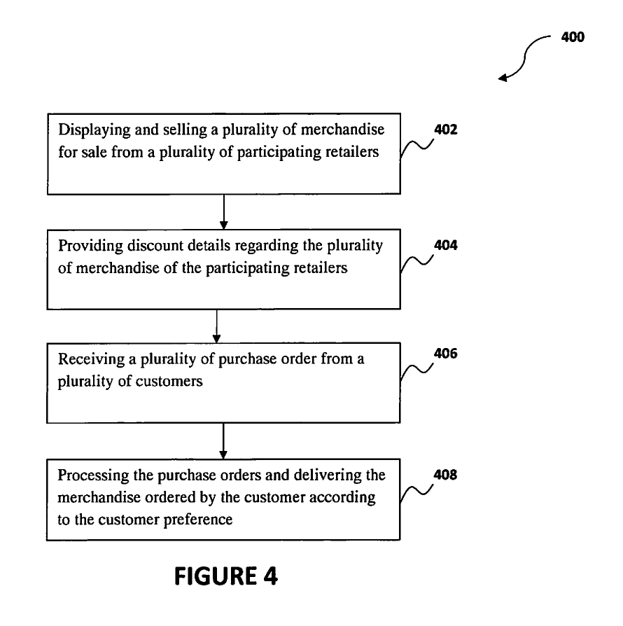

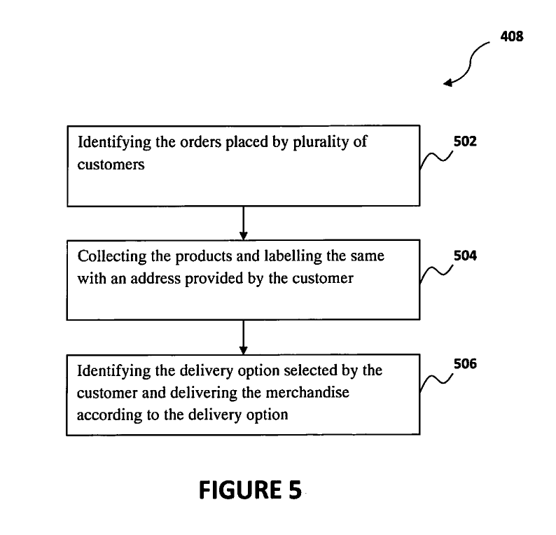

FIG. 4 illustrates the steps of the method for managing a single point of sale of a plurality of merchandise from a plurality of retailer. The method includes the step (402) of displaying and selling a plurality of merchandise for sale from a plurality of participating retailers. The method also includes step (404) of providing discount information regarding the plurality of merchandise of the participating retailers by the crowd sourcing agents and step (406) of receiving a plurality of purchase order from a plurality of customers. Once the discount information are provided, the authenticity of the discount information are checked from the data available in the database. The method further includes step (408) of processing the purchase orders and delivering the merchandise ordered by the customer according to the customer preference. WDS The step of processing the purchase order (408) identifies the store for which the order pertains and directs the order to that particular store for further process. The store associate gets a message in (his/her) hand held device regarding the order. The store associate then scans the bar code to update the status of the order and also prints a label for the shipping. Once the merchandise is packed for shipment according to the order, it goes for delivery to the customer.

According to an embodiment, the step (408) of delivering the merchandise has a plurality of options for delivering the merchandise. The plurality of options for delivering the merchandise include receiving the ordered merchandise at the store or delivering the ordered merchandise to an address specified by the customer or picking up the merchandise from a mall box.

According to an embodiment, the step (408) of delivering the merchandise also includes the step (502) of identifying the orders placed by plurality of customers. The method also includes the step (504) of collecting the products and labelling the same with an address provided by the customer. The method also includes the step (506) of identifying the delivery options selected by the customer and delivering the merchandise according to the delivery options.

The method as described above includes a series of steps and their order of execution in the embodiments of the invention illustrated and described herein is not essential, unless otherwise specified. That is, the steps may be performed in any order, unless otherwise specified, and embodiments of the invention may include additional or fewer steps than those disclosed herein. It may be envisioned that executing or performing a particular step before, contemporaneously with, or after another step is within the scope of the invention.

The website of the system has a collection of regular and discount sale merchandise items listed from multiple retailers which provide a convenient way to shop for the merchandise rather than a customer searching for discount sale by walking from one store to another and/or by searching each individual retailer's web site. The system also provides different ways of delivering the merchandise according to the customer requirement. The system disclosed also helps the local retailers in increasing the foot traffic to their store by sharing the discount sale to the customers.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the embodiments as described herein.

I claim:

1. A system for managing a single point of sale of plurality of merchandise from plurality of retailers, the system comprises:
a) a merchandise aggregation module configured to display and sell a plurality of merchandise from a plurality of participating retailers;
b) a crowd sourcing module configured to provide discount information regarding the plurality of merchandise of the participating retailers to the merchandise aggregation module;
c) an order processing module configured to receive a plurality of purchase orders from a plurality of customers wherein the order processing module processes the purchase orders and delivers the merchandise to the customers.

2. The system as claimed in claim 1, wherein the crowd sourcing module enables a crowd sourcing agent to provide discount information to the merchandise aggregation module.

3. The system as claimed in claim 2, wherein the crowd sourcing agent is at least one of a reseller, retailer or store associate.

4. The system as claimed in claim 2, wherein the crowd sourcing module is further configured to check the authenticity of the discount information provided by the crowd sourcing agent.

5. The system as claimed in claim 1, wherein the crowd sourcing module is further configured to send the discount information to a plurality of platforms.

6. The system as claimed in claim 1, wherein the merchandise aggregation module further enables merchants to offer a combination of merchandise for sale at a single price.

7. The system as claimed in claim 1, wherein the order processing module provides the customer with a plurality of delivery options.

8. The system as claimed in claim 7, wherein the plurality of delivery options has at least one of:
i. to receive the ordered merchandise at the store;
ii. to deliver to an address specified by the customer; and,
iii. to pick up the merchandise from a mall box.

9. The system as claimed in claim 1, wherein the order processing module is further configured to track shipment of the ordered merchandise by the customer.

10. The system as claimed in claim 8, wherein mall box is a box with a plurality of slots for securely keeping the ordered merchandise for the customer who has opted for pickup from the mall box.

11. The system as claimed in claim 1, wherein the order processing module is further capable of printing a shipping label for the order received from the customer.

12. The system as claimed claim 10, wherein the order processing module further includes a mobile robot configured to collect the plurality of ordered merchandise by the plurality of customers from a plurality of stores to the slots in the mall box.

13. The system as claimed in 10, wherein the slot of the mall box includes secure locking facility.

14. The system as claimed in claim 10, wherein an order which is not received by the customer is returned to the merchant's store by the mobile robot.

15. The system as claimed in claim 8, wherein the mall box has doors configured to display advertisements.

16. The system as claimed in claim 1, the system further comprises an incentive module for distributing commission to the crowd sourcing agents.

17. A method for managing a single point of sale of a plurality of merchandise from a plurality of retailer, the method comprising the steps of:
a) displaying and offering for sale a plurality of merchandise from a plurality of participating retailers;
b) providing discount information regarding the plurality of merchandise of the participating retailers by at least one of the crowd sourcing agents;
c) receiving a plurality of purchase orders from a plurality of customers;
d) processing the purchase orders and delivering the merchandise ordered by the customer.

18. The method as claimed in claim 17, wherein the step of delivering the merchandise has a plurality of options for delivering the merchandise.

19. The method as claimed in claim 18, wherein the plurality of options for delivering the merchandise is at least one of:
a) receiving the ordered merchandise at the store;
b) delivering the ordered merchandise to an address specified by the customer; and,
c) picking up the merchandise from a mall box.

20. The method as claimed in claim 18, wherein the step of delivering the merchandise further includes the steps of:
i. identifying the orders placed by plurality of customers;
ii. collecting the merchandise according to the order placed, packing and labelling the merchandise with an address provided by the customer; and,
iii. identifying the delivery option selected by the customer and delivering the merchandise according to the selected delivery option.
